(19) United States
(12) Patent Application Publication
(10) Pub. No.: US 2017/0173623 A1
(43) Pub. Date: Jun. 22, 2017

(54) DEVICE AND METHOD FOR PRODUCING COATINGS OF POROUS COORDINATION POLYMERS BY FLOW OF REAGENTS

(71) Applicant: MATRIX SENSORS, INC., San Diego, CA (US)

(72) Inventors: David K. Britt, El Cerrito, CA (US); Paul R Wilkinson, El Segundo, CA (US); Steven Yamamoto, San Diego, CA (US)

(73) Assignee: MATRIX SENSORS, INC., San Diego, CA (US)

(21) Appl. No.: 15/383,548

(22) Filed: Dec. 19, 2016

Related U.S. Application Data
(60) Provisional application No. 62/269,925, filed on Dec. 18, 2015.

(51) Int. Cl. B05C 9/02; B05C 21/00; B05D 1/30; B05D 1/34; B05D 7/14; B05C 9/10; B05C 9/14

(52) U.S. Cl. CPC B05C 9/02; B05C 9/10; B05C 21/00; B05C 9/14; B05D 1/34; B05D 7/14; B05D 1/30

(57) ABSTRACT

An apparatus and method is provided for coating a surface of a material with at least one film of porous coordination polymer. A body (e.g., a flow cell) has an interior space for holding the material to be coated, at least one inlet, and at least one outlet in communication with the interior space to permit fluid to flow in a downstream direction from the inlet, across the surface of the material in the interior space, and through the outlet. A plurality of flow channels are arranged to flow a plurality of different reagent solutions from respective supply sources to the at least one inlet. The flow channels merge into at least one mixing region, positioned upstream of the interior space, to mix the solutions prior to the mixture contacting the surface of the material in the interior space. At least one pressure source and valve system are arranged with the supply sources and the flow channels to select at least one combination of the reagent solutions to be mixed and to force the selected reagent solutions to flow from their respective supply sources, through the flow channels, and into the mixing region at independently controllable flow rates to regulate respective concentrations of reagents in the mixture.

### CROSS REFERENCE TO RELATED APPLICATIONS

This application claims the benefit of U.S. provisional patent application 62/269,925 filed on Dec. 18, 2015, which application is hereby incorporated by reference in its entirety.

### BACKGROUND

The invention relates generally to devices and methods for the synthesis of porous coordination polymer (PCP), and in particular to devices and methods for coating a surface of a material with a film of one or more porous coordination polymers.

An established method for synthesis of porous coordination polymer (PCP) coatings relies on the stepwise introduction of reagents with an intermediary wash step, often referred to as liquid phase epitaxy. This method requires considerable time and solvent to make a single film, which is undesirable.

### SUMMARY

The present invention provides devices and methods for producing films of porous coordination polymers (e.g., metal-organic frameworks) in the same size range as liquid phase epitaxy, but advantageously using a small fraction of the time and considerably less solvent.

According to an aspect, an apparatus is provided for coating a surface of a material with at least one film. The film comprises at least one porous coordination polymer. The apparatus comprises a body (e.g., a flow cell) having an interior space for holding the material to be coated. The body further includes at least one inlet and at least one outlet in communication with the interior space to permit fluid to flow in a downstream direction from the inlet, across the surface of the material in the interior space, and through the outlet. A plurality of flow channels are arranged to flow a plurality of different reagent solutions from respective supply sources to the at least one inlet. The flow channels merge into at least one mixing region, positioned upstream from the interior space, to mix the solutions prior to the mixture contacting the surface of the material in the interior space. The apparatus also includes fluid delivery means (e.g., at least one pressure source and valve system) arranged with the supply sources and the flow channels to select at least one combination of the reagent solutions to be mixed and to force the selected reagent solutions to flow from their respective supply sources, through the flow channels, and into the mixing region at independently controllable flow rates.

According to another aspect, a method is provided for coating a surface of a material with at least one film. The film comprises at least one porous coordination polymer. The method comprises the step of holding the material to be coated in the interior space of a body. The body includes at least one inlet and at least one outlet in communication with the interior space to permit fluid to flow in a downstream direction from the inlet, across the surface of the material in the interior space, and through the outlet. At least one pump and valve system is utilized to select at least one combination of reagent solutions from a plurality of different reagent solutions in respective supply sources. The selected reagent solutions are forced to flow from their respective supply sources, through a corresponding plurality of flow channels, and into at least one mixing region. The method also comprises the steps of mixing the selected reagent solutions in the mixing region prior to the mixture contacting the surface of the material in the interior space, and forcing the mixture to flow across the surface of the material.

According to another aspect, an apparatus is provided for coating a surface of a material with at least one film. The apparatus comprises a body having at least one inlet, at least one outlet, and an interior space for holding the material to be coated. The inlet and outlet are positioned with respect to the interior space to permit fluid to flow from the inlet, across the surface of the material, and through the outlet. A plurality of flow channels are arranged to flow at least one reagent solution and at least one other solution containing a catalyst from respective supply sources. The catalyst promotes growth of the film when mixed with other reagents. The flow channels are fluidicly connected to the at least one inlet, and the flow channels form at least one union for mixing the reagent and catalyst solutions prior to the mixture contacting the surface of the material in the interior space. The apparatus also comprises fluid delivery means (e.g., at least one pump and valve system) for forcing the reagent and catalyst solutions to flow from their respective supply sources, through the flow channels, and into the interior space at flow rates selected to control the respective concentrations of the reagents and catalyst in the mixture.

According to another aspect, a method is provided for coating a surface of a material with at least one film. The method comprises holding the material to be coated in the interior space of a body having at least one inlet and at least one outlet. The inlet and outlet are positioned with respect to the interior space to permit fluid to flow from the inlet, across the surface of the material, and through the outlet. The method also comprises forcing at least one reagent solution and at least one solution containing a catalyst to flow from respective supply sources through a corresponding plurality of flow channels to the at least one inlet. The catalyst promotes growth of the film. The reagent and catalyst solutions are mixed prior to the mixture contacting the surface of the material in the interior space, and the reagent and catalyst solutions are forced to flow from their respective supply sources and through the corresponding flow channels at flow rates selected to control the respective concentrations of the reagents and catalyst in the mixture. The mixture is forced to flow across the surface of the material to produce the film.

According to another aspect, an apparatus is provided for coating a surface of a material with at least one film. The film comprises at least one porous coordination polymer. The apparatus comprises a body having at least one inlet, at least one outlet, and an interior space for holding the material to be coated. The inlet and outlet are positioned with respect to the interior space to permit fluid to flow from the inlet, across the surface of the material, and through the outlet. At least one flow channel is arranged to flow reagents to the body. The flow channel is fluidicly connected to the inlet. The apparatus also comprises fluid delivery means (e.g., at least one pump and valve system) for forcing the reagents to flow from at least one supply source, through the flow channel, and into the interior space. At least one heat source is arranged to heat the reagents and/or the material in the interior space to a temperature sufficient to initiate growth of the film on the surface.

According to another aspect, a method is provided for coating a surface of a material with at least one film. The film comprises at least one porous coordination polymer. The method comprises holding the material to be coated in the interior space of a body having at least one inlet and at least one outlet. The inlet and outlet are positioned with respect to the interior space to permit fluid to flow from the inlet, across the surface of the material, and through the outlet. Reagents are forced to flow from at least one supply source and through the interior space of the body such that the reagents contact the surface of the material. The method also comprises the step of heating the material in the interior space and/or the reagents to a temperature sufficient to initiate growth of the film on the surface.

### BRIEF DESCRIPTION OF THE DRAWINGS

The foregoing aspects and advantages of the present invention will become better understood upon reading the following detailed description and upon reference to the drawings where:

FIG. 1 is a schematic block diagram of an apparatus for coating a surface of a material with a film of porous coordination polymer, according to an embodiment of the invention.

FIG. 2 is a schematic block diagram of an apparatus having a heat source for activating a reaction to produce a film of porous coordination polymer on a surface of a material, according to another embodiment of the invention.

FIG. 3 is a schematic block diagram of an apparatus arranged to mix reagents with a catalyst and to coat a surface of a material with a film of porous coordination polymer, according to another embodiment of the invention.

FIG. 4 is a schematic block diagram of an apparatus for coating a surface of a material with a film of porous coordination polymer while monitoring growth of the film, according to another embodiment of the invention.

FIG. 5 shows a schematic block diagram of another apparatus for coating a surface of a material with a film of porous coordination polymer while monitoring growth of the film, according to another embodiment of the invention.

### DETAILED DESCRIPTION OF PREFERRED EMBODIMENTS

In the following description, it is understood that all recited connections between structures can be direct operative connections or indirect operative connections through intermediary structures. A set of elements includes one or more elements. Any recitation of an element is understood to refer to at least one element. A plurality of elements includes at least two elements. Unless otherwise required, any described method steps need not be necessarily performed in a particular illustrated order. A first element (e.g. a signal or data) derived from a second element encompasses a first element equal to the second element, as well as a first element generated by processing the second element and optionally other data. Making a determination or decision according to a parameter encompasses making the determination or decision according to the parameter and optionally according to other data. Unless otherwise specified, an indicator of some quantity/data may be the quantity/data itself, or an indicator different from the quantity/data itself. Computer programs described in some embodiments of the present invention may be stand-alone software entities or sub-entities (e.g., subroutines, code objects) of other computer programs. Computer readable media encompass non-transitory media such as magnetic, optic, and semiconductor storage media (e.g. hard drives, optical disks, flash memory, DRAM), as well as communications links such as conductive cables and fiber optic links. According to some embodiments, the present invention provides, inter alia, computer systems comprising hardware (e.g. one or more processors and associated memory) programmed to perform the methods described herein, as well as computer-readable media encoding instructions to perform the methods described herein.

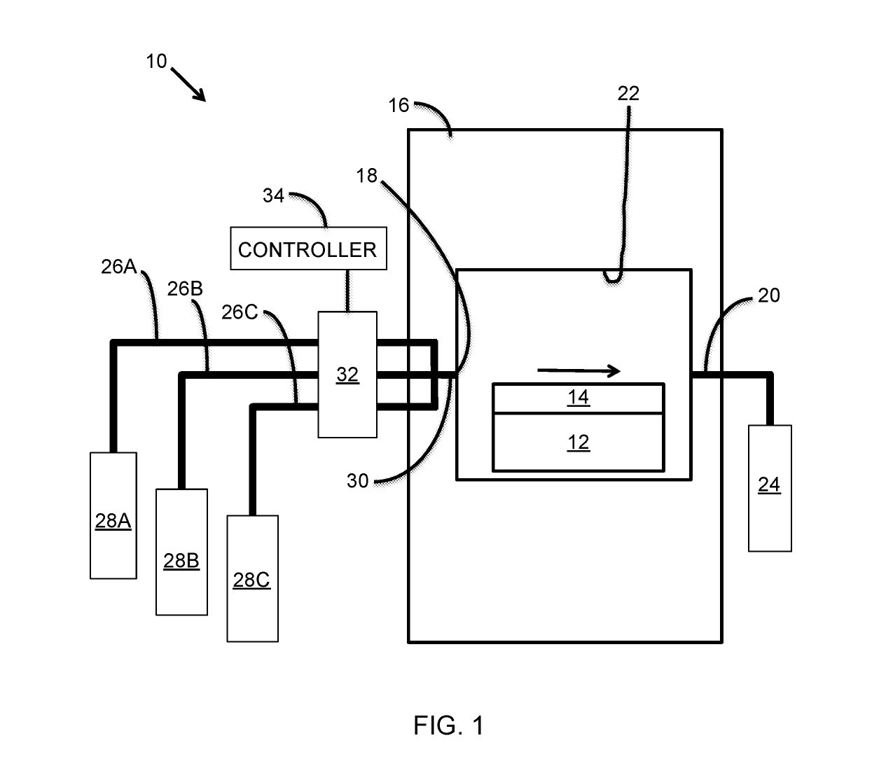

FIG. 1 shows an apparatus 10 for coating at least one surface of a material (e.g., a substrate 12) with a film 14 comprising at least one porous coordination polymer. The surface of the substrate 12 typically comprises a bare metal oxide, a noble metal, a metal oxide coated with a functionalized self-assembled monolayer (SAM), or a more complex material including at least one of these components. The film 14 (not drawn to scale) preferably has a thickness in the range of about 10 nm to 10 μm.

Suitable porous coordination polymers include porous crystalline materials such as a metal-organic frameworks (MOFs) or porous coordination frameworks. Preferred MOF subclasses include Zeolitic imidazolate framework (ZIF), IRMOF, and Multivariate MOF (MTV-MOF) made using a mix of organic linkers having the same geometry but varied chemical functionality. Suitable porous coordination polymers also include a covalent organic framework (COF) in which the framework includes covalent chemical bonds rather than metal coordination bonds. In rare embodiments, the porous coordination polymers comprise non-crystalline porous materials such as metal-organic polyhedron having discreet porous cages, porous metal-organic polymer, or metal-organic gel.

Metal-organic frameworks are an expanding class of porous crystalline materials that are built up from nodes of metal ions connected by organic linkers. These materials can typically be engineered to have pore apertures with a width or diameter in a range of less than 1 Angstrom to about 30 Angstroms (Yaghi, et. al., Nature 423, 705-714, Jun. 12, 2003). A class of exotic MOFs (“MOF-74”) with pore aperture diameters of 98 Angstroms have also been demonstrated (Deng, et. al., Science 336, 1018, 2012). MOFs with varying pore sizes can selectively adsorb molecules based on the size of the molecules. For example, engineered MOFs with pore sizes designed for carbon dioxide (CO₂) adsorption can separate gases in industrial processes (Du, et. al., J. Am. Chem. Soc., 2013, 135 (2), pp 562-565). MOFs can also be used as receptor layers with a Quartz Crystal Microbalance (QCM) to act as a chemical sensor in controlled environments.

The pore size of the MOF (e.g., the average width, diameter or volume of the pore apertures) is preferably chosen to achieve a degree of selectivity of adsorbed molecules based on the size of the molecules. In some embodiments, the material (e.g., a substrate) that is coated with a film is a resonating member of a resonant sensor. Resonant sensors (e.g., cantilever, membrane and piezoelectric resonator-based sensors) use target molecules adsorbed in the sensing material (e.g., a film of PCP coated on the sensor) to change properties that are reflected in the resonance frequency. In some embodiments, an array of resonant sensors has MOFs of varying pore size on the resonating members of the sensors. The resonant sensors may be used as chemical sensors, where ambient molecular concentrations are monitored in real-time and the multiple sensors with varied pore sizes provide selectivity based on molecule size.

The apparatus 10 includes a body 16 (e.g., a flow cell) having at least one inlet 18, at least one outlet 20, and an interior space 22 for holding the substrate 12 to be coated. In some embodiments, the interior space 22 has a notch or other holding mechanism to align and hold the substrate 12 in a suitable orientation for reagent solutions to flow across at least one surface of the material to be coated. The inlet 18 and the outlet 20 are positioned with respect to the interior space 22 to permit fluid to flow in a downstream direction from the inlet 18, across at least one surface of the substrate 12 (flow direction indicated by arrow), and through the outlet 20 to a waste collector 24. In some embodiments, a mixture of reagent solutions is flowed continuously across the substrate 12, significantly reducing the time needed to coat the material with the film of porous coordination polymer.

A plurality of flow channels 26A, 26B, 26C (e.g., tubes or conduits) are arranged to flow reagent solutions from respective reagent supply sources 28A, 28B, 28C (e.g., containers). The flow channels 26A, 26B, 26C are fluidicly connected to the at least one inlet 18. The flow channels merge into at least one mixing region 30 that is positioned upstream of the interior space to mix the solutions prior to the mixture contacting the surface of the material in the interior space 22. In some embodiments, the mixing region 30 is positioned inside the body 16. In some embodiments, the mixing region is an intersection or union of the flow channels 26A, 26B, 26C positioned between the reagent supply sources 28A, 28B, 28C and the at least one inlet 18.

The mixing of the reagent solutions just prior to the mixture contacting the surface of the substrate 12 is effective in preventing premature nucleation of the polymer in solution, which is undesirable as it may lead to deposition of large particles and to reagent depletion. To prevent premature nucleation, the reagents are preferably separated into at least two non-reacting solutions that are stored in at least two different ones of the supply sources 28A, 28B, until they contact each other in the mixing region 30. For example, a MOF typically comprises at least one bidentate organic compound coordinated to at least one metal ion, and the metal ion is held in a separate solution from the solution containing the organic compound, until the separate solutions are mixed in the mixing region 30. Many recipes for metal-organic frameworks are known in the prior art. For example, MOFs are described in U.S. Pat. No. 5,648,508, U.S. Pat. No. 8,697,191, EP-A-0 790 253, M. O'Keeffe et al., J. Sol. State Chem., 152 (2000), pages 3 to 20, H. Li et al., Nature 402, (1999), page 276, M. Eddaoudi et al., Topics in Catalysis 9, (1999), pages 105 to 111, B. Chen et al., Science 291, (2001), pages 1021 to 1023, DE-A-101 11 230, DE-A 10 2005 053430, WO-A 2007/054581, WO-A 2005/049892 and WO-A 2007/023134.

The apparatus 10 also includes fluid delivery means for forcing selected ones of the reagent solutions to flow from their respective reagent supply sources 28A, 28B, 28C, through the flow channels 26A, 26B, 26C, and into the mixing region 30. The flow rates of the reagent solutions are selected to control the respective concentrations of the reagents in the mixture contacting the substrate 12. The fluid delivery means typically comprises at least one pump and valve system 32 arranged to force the reagent solutions to flow from their respective reagent supply sources 28A, 28B, 28C and through the flow channels 26A, 26B, 26C at independently controllable flow rates. In some embodiments, at least one controller 34 is programmed to control the pump and valve system 32 according to user-selectable parameters. The user-programmable control is preferably provided by LabVIEW (Laboratory Virtual Instrument Engineering Workbench) which is a system-design platform and development environment commercially available from National Instruments.

The controller 34 is preferably programmable to vary the combination of reagent solutions that are pumped from their respective reagent supply sources 28A, 28B, 28C and through the flow channels 26A, 26B, 26C. For example, in some embodiments the flow rates of the reagent solutions are varied over time in a substantially periodic (e.g., sinusoidal) pattern. An example of a suitable pump is a rotary piston pump with built-in flow control (e.g., valves) for directing fluid to move in different flow channels at independently controllable flow rates. In other embodiments, other types of pumps may be employed such as diaphragm, piston, plunger, and centrifugal pumps. In some embodiments, valves are separate from the at least one pump. The fact that one or more valves may be built into the pump system is just a specific embodiment and not limiting. In alternative embodiments, the fluid delivery means may comprise any source of differential pressure. For example, pressure may be supplied to the headspace of the reagent supply sources 28A, 28B, 28C to force fluid flow at desired flow rates.

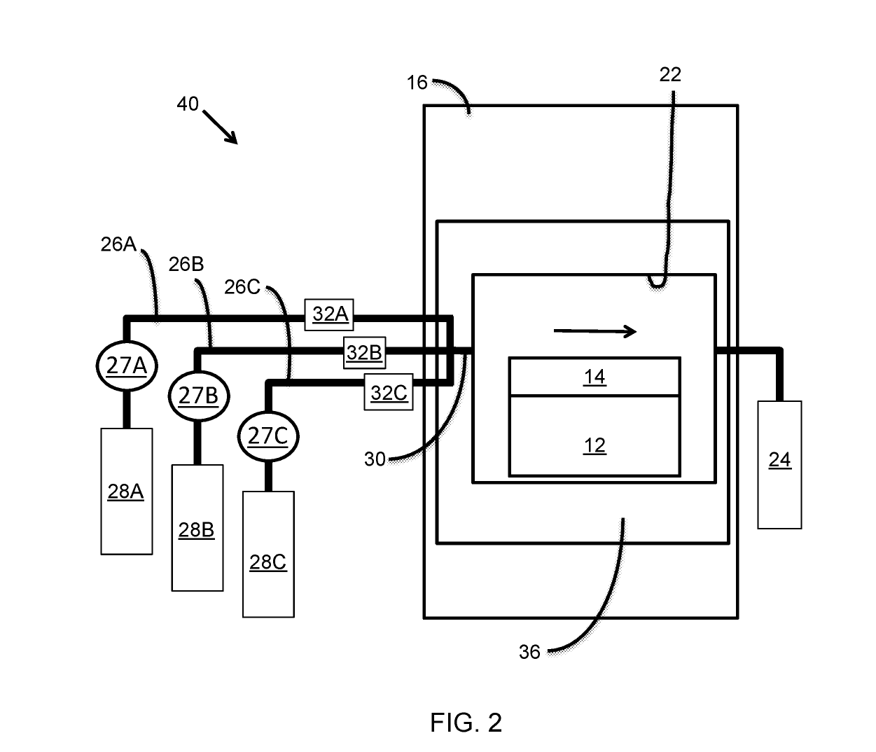

FIG. 2 illustrates another embodiment of an apparatus 40 for coating at least one surface of a material (e.g., a substrate 12) with a film 14. The fluid delivery means comprises a plurality of valves 27A, 27B, 27C and pumps 32A, 32B, 32C. The valves 27A, 27B, 27C are arranged to control fluid flow from the supply sources 28A, 28B, 28C through the flow channels 26A, 26B, 26C to select the reagent solutions to be mixed. The pumps 32A, 32B, 32C are arranged to force the selected reagent solutions to flow from their respective supply sources 28A, 28B, 28C, through the flow channels 26A, 26B, 26C, and into the mixing region 30 at independently controllable flow rates. In this example, each of the flow channels 26A, 26B, 26C has its own corresponding one of the valves 27A, 27B, 27C and pumps 32A, 32B, 32C to control flow of the selected reagent solutions from the corresponding supply sources 28A, 28B, 28C. Many other examples of fluid delivery means, with different combinations of valves and pumps, are possible. It will be apparent to one skilled in the art that there are many possible permutations of one or more pressure sources (e.g., pumps) and flow controllers (e.g., valves) to select which of the reagent solutions are to flow at any given time and independently control the flow rates of the solutions.

An optional heat source 36 is arranged to heat the reagents and/or the substrate 12 in the interior space 22 to a temperature sufficient to initiate growth of the film of porous coordination polymer on the surface of the substrate 12. In some embodiments, the heat source 36 is arranged to heat the reagent solutions prior to the mixture of reagent solutions contacting the surface of the substrate 12 in the interior space 22. In other embodiments, the heat source 36 is arranged to heat the material in the interior space 22 (e.g., the substrate 12) while the mixture of reagents is forced to flow across the surface of the substrate 12. In some embodiments, both the reagents and substrate 12 are heated by the at least one heat source 36.

In any of these heating embodiments, the heating of the reagents and/or of the material to be coated in the interior space 22 to a temperature sufficient to initiate growth of the film of porous coordination polymer on the surface is effective in preventing early nucleation of the polymer in solution. Premature nucleation is undesirable as it may lead to deposition of large particles and to reagent depletion. When heat is used to initiate the growth of the film, one reagent supply source 28A may be connected to the body 16 by a flow channel 26A. The one reagent supply source 28A may contain all the necessary reagents for film growth when activated by heat. Alternatively, the apparatus 40 may comprise multiple flow channels 26A, 26B, 26C arranged to flow multiple reagent solutions from respective reagent supply sources 28A, 28B, 28C as in previous embodiments.

In some embodiments, the reagents are cooled to a temperature below room temperature prior to forcing the reagents to flow from one or more reagent supply sources 28A, 28B, 28C. Room temperature is typically about 22° C. The heat source 36 may be part of a more complete environmental control system that controls multiple environmental parameters (e.g., temperature and pressure) within the body 16 of the apparatus 40. In preferred embodiments, the heat source 36 heats the interior space 22 and/or the substrate 12 using convection, although many other suitable heat sources may be used in alternative embodiments.

The flow rates of the reagent solutions may vary. Flow rates are selected to control the respective concentrations of the reagents in the mixture contacting the surface to be coated. An easy way to adjust concentrations is to vary the relative flow rates of one reagent solution to another. The reaction of a reagent A with a reagent B removes A and B from solution at some rate as they meet in the mixing region 30. So the concentration is preferably maintained in a range where enough material is reacting (reagent A and B) to form a layer of film, but not at concentrations so high that we sediment out particles, which is undesirable for the layer of film being formed. The flow rate and temperature both contribute to the process. Flow rates are typically selected to maintain the concentration of each reagent in a desired range based on the rate at which reagents are removed from solution by undergoing reaction. The ideal concentration range is high enough that the reaction occurs sufficiently quickly, but not so high as to lead to rapid particle formation and sedimentation onto the substrate from solution.

Pumps and valves may be controlled for continuous flow or for more complex flow rate profiles, such as a ramp from zero to a high flow rate F, then to a lower flow rate f, and then back to zero again. Each reagent solution may have the same or different flow rate profiles. In some embodiments, these flow rate profiles are coordinated with different temperatures. For example, a recipe for creating a MOF film could include: Step 1 at temperature 20° C., flow Reagent Solution A at flow rate F_{A}, and Reagent Solution B at flow rate F_{B} for 20 minutes. Step 2 at temperature 20° C., Reagents Solutions A and B are off, turn on Wash C at flow rate F_{C} for 5 minutes. Step 3 at temperature 200° C., flow Reagent Solution A at flow rate F₃ and Reagent Solution B at flow rate F₄ for 32 minutes. Step 4 at Temperature 30° C., 20 minutes, no reagents. These and many other recipes are possible where flow rate profiles are coordinated with different temperatures for different time periods.

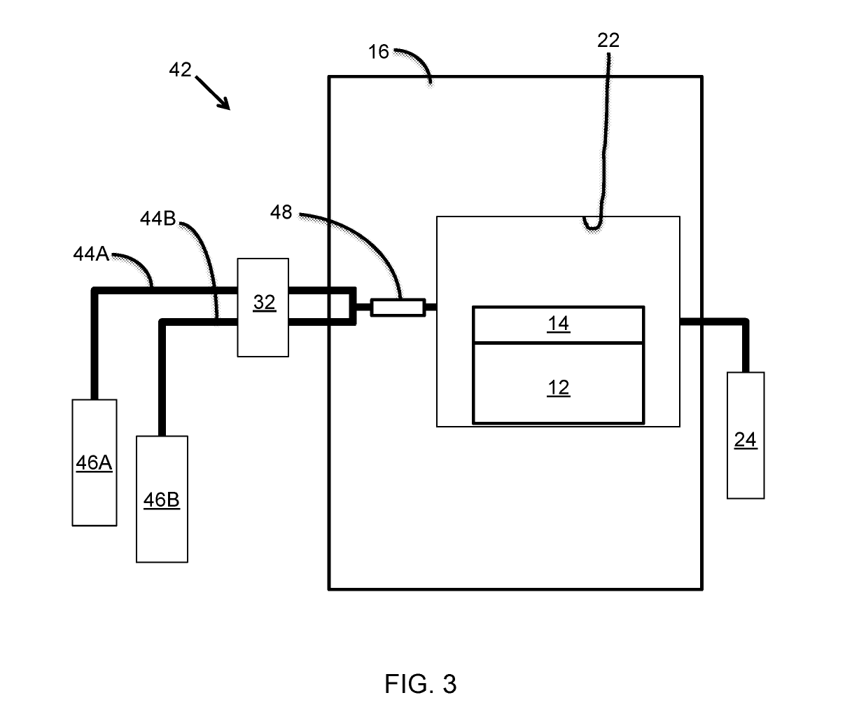

FIG. 3 illustrates another embodiment of an apparatus 42 for coating the substrate 12 with a film 14 of porous coordination polymer. In this embodiment, a plurality of flow channels 44A, 44B are arranged to flow at least one reagent solution and at least one solution containing a catalyst from respective supply sources 46A, 46B. The flow channels 44A, 44B merge into a mixing region 48 inside the body 16. The mixing region 48 is positioned upstream from the interior space 22 to mix the reagent and catalyst solutions prior to the mixture contacting the substrate 12 in the interior space 22. The mixing of the reagents and catalyst just prior to the mixture contacting the surface of the material to be coated is effective in preventing nucleation of the polymer in solution, which is undesirable as it may lead to deposition of large particles and to reagent depletion. The reagent and catalyst solutions are forced to flow from their respective supply sources 46A, 46B and through the corresponding flow channels 44A, 44B at flow rates selected to control the respective concentrations of the reagents and catalyst in the mixture.

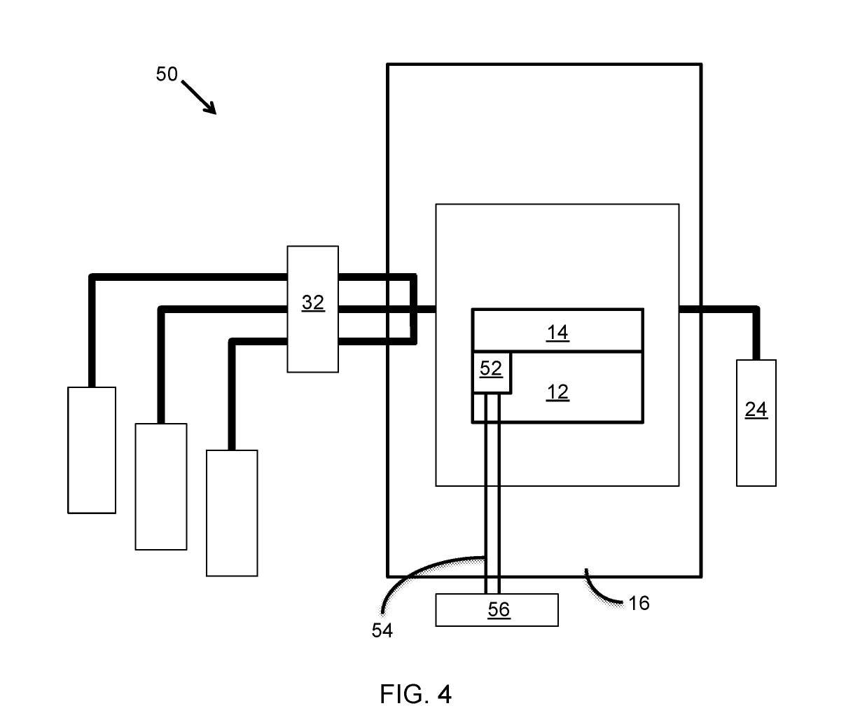

FIG. 4 illustrates another embodiment of an apparatus 50 for coating the substrate 12 with a film 14 of porous coordination polymer. In this embodiment, at least one sensor 52 is arranged with respect to the body 16 to monitor growth of the film 14 on the substrate 12. The sensor 52 preferably has electrical connections 54 to readout electronics 56 outside of the body 16 (e.g., outside of the flow cell). In some embodiments, the sensor 52 may be part of the substrate 12, and in other embodiments, the sensor 52 is a separate element.

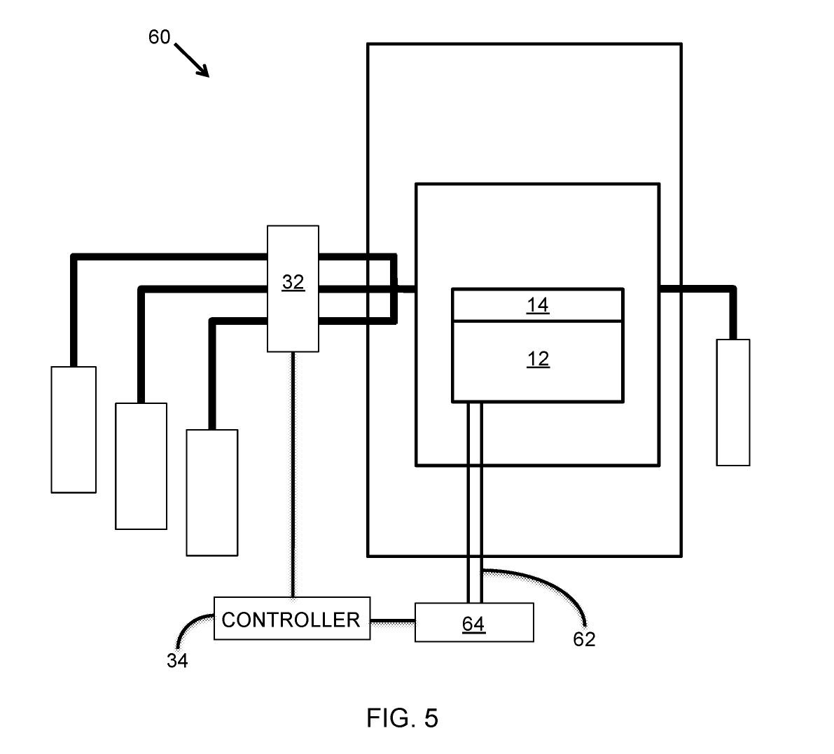

FIG. 5 illustrates another embodiment of an apparatus 60 for coating the substrate 12 with a film 14 of porous coordination polymer. In this embodiment, at least one electrical circuit 62 is arranged to measure changes in at least one electrical property of the substrate 12 in response to growth of the film 14 on the substrate 12. The electrical circuit 62 connects the substrate 12 to readout electronics 64 to monitor one or more electrical properties of the substrate 12 during film growth. At least one of the monitored electrical properties is indicative of a thickness of the film 14 on the substrate 12.

For example, in some embodiments, the substrate 12 is a mass transducer. The film deposition process and thickness of the film 14 is monitored by running the transducer during film growth. A controller 34 is in communication with the fluid delivery means (e.g., pump and valve system 32) and the electrical circuit via readout electronics 64. In some embodiments, the controller 34 is programmed to stop flow of the reagent solutions in response to at least one electrical signal indicative of a desired thickness of the film 14 on the substrate 12. For example, the sensor data (e.g., electrical signals indicative of film growth) is fed into the pump controller 34, which stops the flow of the reagent solutions and initiates rinsing of the substrate 12 with solvent, once the desired film thickness is achieved.

### EXAMPLES

### Example 1

Multiple reagent solutions are flowed through the apparatus at constant flow rates and at room temperature (e.g., 22° C.) for a fixed period of time. Reaction variables are selected according to a desired film thickness (e.g., in the range of 10 nm to 10 μm).

Referring to FIG. 1, the substrate 12 is placed in the interior space 22 (e.g., the interior chamber of a flow cell). In this example, the substrate 12 to be coated is a resonating crystal (e.g., a quartz crystal oscillator) with gold electrodes. At least one of the gold electrodes, which is on top of the resonating crystal, is coated with a SAM, onto which the film 14 is grown. To produce the film 14 (a MOF in this example), the quartz crystal oscillator is placed and sealed in the interior space 22 of the flow cell. The pump and valve system 32 is activated to flow first and second reagent solutions from supply sources 28A and 28B, respectively, through the interior space 22, and to the waste collector 24. The first reagent solution is 0.5 mM 3,5-dimethylpyrazole-4-carboxylic acid in ethanol, and the second reagent solution is 1 mM zinc acetate in ethanol. The first reagent solution is pumped at a flow rate of 1 mL/min for a time period of 1 hour, and the second reagent solution, that is mixed with the first reagent solution in the mixing region 30, is pumped at a flow rate of 1 mL/min for a time period of 1 hour. After 1 hour of film growth, the pump and valve system 32 stops the flows of the first and second reagent solutions. The pump and valve system 32 is then activated to flow ethanol from supply source 28C through the interior space 22 for a time period of 5 minutes to remove residual reagent solution. Optionally, the interior space 22 is then flushed with air. The substrate 12 coated with the film 14 is then removed from the interior space 22 of the flow cell.

### Example 2

Flow rates of the reagents are varied with time. A first reagent flows through the interior space 22 of the flow cell prior to the flow of other reagents to allow that first reagent to react with the surface in the absence of the other reagents.

Referring to FIG. 1, the substrate 12 is placed in the interior space 22 (e.g., the interior chamber of a flow cell). In this example, the substrate 12 to be coated is a resonating crystal (e.g., a quartz crystal oscillator) with gold electrodes. At least one of the gold electrodes, which is on top of the resonating crystal, is coated with a SAM, onto which the film 14 is grown. To produce the film 14 (a MOF in this example), the quartz crystal oscillator is placed and sealed in the interior space 22 of the flow cell. The pump and valve system 32 is activated to flow a first reagent solution from supply source 28A through the interior space 22 and to the waste collector 24 at a flow rate of 1 mL/min for a time period of 5 minutes. The first reagent solution is 1 mM zinc acetate in ethanol. At the end of the 5 minute time period, the pump and valve system 32 begins to flow a second reagent solution from the supply source 28B through the interior space 22 and to the waste collector 24, at a flow rate of 1 mL/min for a time period of 1 hour. The second reagent solution is 0.5 mM 3,5-dimethylpyrazole-4-carboxylic acid in ethanol. After 1 hour of film growth, the pump and valve system 32 stops the flows of the reagent solutions. The pump and valve system 32 is then activated to flow ethanol from supply source 28C through the interior space 22 for a time period of 5 minutes to remove residual reagent solution. Optionally, the interior space 22 is then flushed with air. The substrate 12 coated with the film 14 is then removed from the interior space 22 of the flow cell.

### Example 3

A first PCP film (seed layer) is grown using a first combination of reagents, after which a second combination of reagents is flowed, optionally followed by other combinations of reagents, resulting in a film with layers of different PCP materials.

Referring to FIG. 1, the substrate 12 is placed in the interior space 22 (e.g., the interior chamber of a flow cell). In this example, the substrate 12 to be coated is a resonating crystal (e.g., a quartz crystal oscillator) with gold electrodes. At least one of the gold electrodes, which is on top of the resonating crystal, is coated with a SAM, onto which the layers of different PCP materials are grown. The quartz crystal oscillator is placed and sealed in the interior space 22 of the flow cell. The pump and valve system 32 is activated to flow first and second reagent solutions through apparatus 10. The first reagent solution is 0.5 mM 3,5-dimethylpyrazole-4-carboxylic acid in ethanol, and the second reagent solution is 1 mM zinc acetate in ethanol. The first and second reagent solutions are pumped at flow rates of 1 mL/minute each for a time period of 10 minutes to produce a seed layer on the surface. After this first combination of reagents is pumped for 10 minutes to produce the seed layer on the surface, the pump and valve system 32 switches to flow a second combination of reagents, 0.5 mM 3-isopropylpyrazole-4-carboxylic acid in ethanol and 1 mM zinc acetate in ethanol, at flow rates of 1 mL/minute each through the apparatus 10 for a time period of 1 hour. After 1 hour of film growth, the pump and valve system 32 stops the flows of the reagent solutions. The pump system 32 is then activated to flow ethanol from supply source through the interior space 22 for a time period of 5 minutes to remove residual reagent solution. Optionally, the interior space 22 is then flushed with air. The substrate 12 is coated with the film 14 having layers of different PCP material.

### Example 4, FIG. 1

Flow rates of reagent solutions are varied over time in a periodic (e.g., sinusoidal) pattern to improve film quality by alternating which reagent is present in higher concentration in the mixture.

Referring to FIG. 1, the substrate 12 is placed in the interior space 22 (e.g., the interior chamber of a flow cell). In this example, the substrate 12 to be coated is a resonating crystal (e.g., a quartz crystal oscillator) with gold electrodes. At least one of the gold electrodes, which is on top of the resonating crystal, is coated with a SAM, onto which the film 14 is grown. To produce the film 14, the quartz crystal oscillator is placed and sealed in the interior space 22 of the flow cell. The pump and valve system 32 is activated to flow a first reagent solution, 1 mM zinc acetate in ethanol, at a flow rate of 1 mL/min through the apparatus 10. A second reagent solution, 0.5 mM 3,5-dimethylpyrazole-4-carboxylic acid in ethanol, remains at a flow rate of 0 mL/minute. A LabView virtual instrument controls the pump flow rates continuously. The LabView program then automatically adjusts the flow rates of the two reagent solutions with time such that the flow rate of each follows a sinusoidal pattern, where the sum of the flow rates of each reagent solution is always equal to 2 mL/minute. After 1 hour of film growth, the pump system 32 stops the flows of the reagent solutions. The pump system 32 is then activated to flow ethanol through the interior space 22 for a time period of 5 minutes to remove residual reagent solution. Optionally, the interior space 22 is then flushed with air. The substrate 12 coated with the film 14 is then removed from the interior space 22 of the flow cell.

### Example 5

Heating of the reagents and/or the material to be coated to initiate growth of the film on the surface.

Referring to FIG. 2, the substrate 12 is placed in the interior space 22 (e.g., the interior chamber of a flow cell). In this example, the substrate 12 to be coated is a resonating crystal (e.g., a quartz crystal oscillator) with gold electrodes. At least one of the gold electrodes, which is on top of the resonating crystal, is coated with a SAM, onto which the film 14 is grown. To produce the film 14, the quartz crystal oscillator is placed and sealed in the interior space 22 of the flow cell. The heat source 36 is set to heat the interior space 22, substrate 12 and reagent solutions to a temperature of 50° C. The pump and valve system 32 is activated to flow ethanol through the apparatus 10 at a flow rate of 2 mL/minute. Once the target temperature is reached, the pump and valve system 32 stops the flow of ethanol. The pump system 32 is then activated to flow first and second reagent solutions from supply sources through the apparatus 10, and to the waste collector 24. The first reagent solution is 0.5 mM 3,5-dimethylpyrazole-4-carboxylic acid in ethanol, and the second reagent solution is 1 mM zinc acetate in ethanol. The first reagent solution is pumped at a flow rate of 1 mL/min for a time period of 1 hour, and the second reagent solution is pumped at a flow rate of 1 mL/min for a time period of 1 hour. After 1 hour of film growth, the pump and valve system 32 stops the flows of the reagent solutions. The pump system 32 is then activated to flow ethanol through the interior space 22 for a time period of 5 minutes to remove residual reagent solution. Optionally, the interior space 22 is then flushed with air. The substrate 12 coated with the film 14 is then removed from the interior space 22 of the flow cell.

### Example 6

Reagents and at least one catalyst are mixed prior to contacting the surface to be coated.

Referring to FIG. 3, the substrate 12 is placed in the interior space 22 (e.g., the interior chamber of a flow cell). In this example, the substrate 12 to be coated is a resonating crystal (e.g., a quartz crystal oscillator) with gold electrodes. At least one of the gold electrodes, which is on top of the resonating crystal, is coated with a SAM, onto which the film 14 is grown. To produce the film 14, the quartz crystal oscillator is placed and sealed in the interior space 22 of the flow cell. The pump and valve system 32 is activated to flow a reagent solution from supply source 46A through the apparatus 10 to the waste collector 24. The reagent solution is 0.5 mM 3,5-dimethylpyrazole-4-carboxylic acid and 1 mM zinc nitrate in ethanol. The reagent solution is pumped at a flow rate of 2 mL/minute for a time period of 1 hour. The pump and valve system 32 also pumps a catalyst solution from supply source 46B at a flow rate of 0.1 mL/min for a time period of 1 hour. The catalyst solution is 0.1 mM sodium hydroxide in ethanol. The catalyst promotes growth of the film 14, and is mixed with the reagent solution prior to contacting the surface to be coated. After 1 hour of film growth, the pump and valve system 32 stops the flows of the reagents and the catalyst. The pump and valve system 32 is then activated to flow ethanol through the interior space 22 for a time period of 5 minutes to remove residual reagent solution. Optionally, the interior space 22 is then flushed with air. The substrate 12 coated with the film 14 is then removed from the interior space 22 of the flow cell.

### Example 7

Grow a self-assembled monolayer (SAM) on a gold-coated substrate, and produce a MOF film over the SAM.

A substrate coated with gold is loaded into a flow cell. The substrate is rinsed by flowing water, acetone, and isopropanol through the cell sequentially. The substrate is cleaned by flowing either or both of a 5/1/1 mixture of water/30% solution of ammonium hydroxide/30% solution of hydrogen peroxide and a 5/1/1 mixture of water/40% solution of hydrochloric acid/30% solution of hydrogen peroxide through the cell. If both solutions are used, an ethanol rinse step is be performed between them to avoid mixing the acid and base. The substrate is rinsed by flowing ethanol through the cell. To grow the self-assembled monolayer (SAM), a solution of 0.2 mM 16-mercaptohexadecanoic acid (which forms the SAM) and 0.02 mM acetic acid (an additive to prevent multilayer SAM growth) in ethanol is flowed across the cell. The substrate is allowed to sit in the solution undisturbed for >12 hours.

The substrate is rinsed by flowing ethanol through the cell. To grow the MOF, three solutions are flowed through the cell in an ABCBABCB pattern (where B is a rinse step to remove the components of A and C that have not fully bound to the surface of the substrate). Solution A is a 1 mM solution of copper(II) acetate in ethanol. Solution B is ethanol. Solution C is a 0.2 mM solution of trimesic acid in ethanol. The substrate is rinsed by flowing ethanol through the cell. Air is pumped through the cell to remove liquid solvents. Solvent remaining in the pores of the MOF is removed by heating in air to 100 degrees C. (the temperature may vary depending on the MOF). The substrate is removed from the flow cell.

The description above illustrates embodiments of the invention by way of example and not necessarily by way of limitation. Many other embodiments and examples of the apparatus and method are possible. Accordingly, the scope of the invention should be determined by the following claims and their legal equivalents.

What is claimed is:

1. An apparatus for coating at least part of a surface of a material with at least one film, wherein the film comprises at least one porous coordination polymer, the apparatus comprising:
a) a body having an interior space for holding the material to be coated, wherein the body further includes at least one inlet and at least one outlet in communication with the interior space to permit fluid to flow in a downstream direction from the inlet, across the surface of the material in the interior space, and through the outlet;
b) a plurality of flow channels arranged to flow a plurality of different reagent solutions from respective supply sources to the at least one inlet, wherein the flow channels merge into at least one mixing region positioned upstream from the interior space to mix the solutions prior to the mixture contacting the surface of the material in the interior space; and
c) fluid delivery means arranged with the supply sources and the flow channels to select at least one combination of the reagent solutions to be mixed and to force the selected reagent solutions to flow from their respective supply sources, through the flow channels, and into the mixing region at independently controllable flow rates.

2. The apparatus of claim 1, wherein the fluid delivery means comprises at least one pump and valve system, and the apparatus further comprises at least one controller programmed to control the pump and valve system to perform the steps of flowing a first combination of the solutions for a first time sufficient to produce at least one seed layer on the surface and then flowing at least a second combination of the solutions for a second time sufficient to grow the film over the seed layer.

3. The apparatus of claim 1, wherein the fluid delivery means comprises at least one pump and valve system, and the apparatus further comprises at least one controller programmed to control the pump and valve system according to user-selectable parameters.

4. The apparatus of claim 3, wherein the controller is programmable to vary the combination of the solutions that are pumped from their respective reagent supply sources and through the flow channels.

5. The apparatus of claim 3, wherein the controller is programmable to vary the flow rates with time to adjust respective concentrations of reagents in the mixture.

6. The apparatus of claim 5, wherein the flow rates are varied in a substantially periodic pattern.

7. The apparatus of claim 1, further comprising at least one heat source arranged to heat the solutions prior to the mixture of solutions contacting the surface of the material in the interior space.

8. The apparatus of claim 1, further comprising at least one heat source arranged to heat the material held in the interior space.

9. The apparatus of claim 1, wherein the mixing region is positioned inside the body.

10. The apparatus of claim 1, wherein the mixing region comprises an intersection or union of the flow channels between the supply sources and the inlet.

11. The apparatus of claim 1, further comprising at least one electrical circuit arranged to measure at least one electrical property of the material to monitor growth of the film on the surface.

12. The apparatus of claim 11, further comprising at least one controller in communication with the fluid delivery means and the electrical circuit, wherein the controller is programmed to stop the flow of solutions in response to at least one electrical signal indicative of a desired thickness of the film.

13. A method for coating at least part of a surface of a material with at least one film, wherein the film comprises at least one porous coordination polymer, the method comprising:
a) holding the material to be coated in the interior space of a body, wherein the body includes at least one inlet and at least one outlet in communication with the interior space to permit fluid to flow in a downstream direction from the inlet, across the surface of the material in the interior space, and through the outlet;
b) utilizing at least one pump and valve system to select at least one combination of reagent solutions from a plurality of different reagent solutions in respective supply sources and forcing the selected solutions to flow from their respective supply sources, through a corresponding plurality of flow channels, and into at least one mixing region;
c) mixing the selected reagent solutions in the mixing region prior to the mixture contacting the surface of the material in the interior space; and
d) forcing the mixture to flow across the surface of the material.

14. The method of claim 13, wherein the mixture is flowed continuously across the surface.

15. The method of claim 13, further comprising the step of monitoring growth of the film on the surface, wherein the growth of the film is monitored using at least one electrical circuit arranged to measure at least one electrical property of the material.

16. The method of claim 15, further comprising the step of utilizing at least one controller, in communication with the fluid delivery means and the electrical circuit, to stop the flow of solutions in response to at least one electrical signal indicative of a desired thickness of the film.

17. The method of claim 13, wherein the surface comprises a bare oxide, a noble metal, or a surface coated with a self-assembled monolayer.

18. The method of claim 13, wherein the wherein the material comprises a resonating member of a resonant sensor.

19. The method of claim 13, further comprising the step of heating the solutions prior to the mixture of solutions contacting the surface of the material in the interior space.

20. The method of claim 13, further comprising the step of heating the material while forcing the mixture to flow across the surface.

21. The method of claim 13, further comprising the step of varying with time the combination of solutions that are forced to flow from their respective supply sources and through the flow channels.

22. The method of claim 21, wherein the step of varying with time the combination of solutions that are forced to flow from their respective supply sources and through the flow channels comprises flowing a first combination of the reagent solutions for a first time sufficient to produce at least one seed layer on the surface and subsequently flowing at least a second combination of the reagent solutions for a second time sufficient to grow the film over the seed layer.

23. The method of claim 13, wherein the selected reagent solutions are forced to flow through the flow channels and into the mixing region at independently controllable flow rates to regulate respective concentrations of reagents in the mixture.

24. The method of claim 23, further comprising the step of varying at least one of the flow rates with time to adjust respective concentrations of reagents in the mixture.

25. The method of claim 24, wherein the flow rates are varied over time in a substantially periodic pattern.

26. The method of claim 13, wherein at least one of the selected reagent solutions contains a catalyst that promotes growth of the porous coordination polymer when mixed with at least one other selected reagent solution.
